(19) United States
(12) Patent Application Publication
(10) Pub. No.: US 2008/0153454 A1
(43) Pub. Date: Jun. 26, 2008

(54) Emergency service in a communication system

(75) Inventors: Asko Haapapuro, Oulu (FI); Marko Akselin, Oulu (FI); Jani R. Manninen, Oulu (FI); Veli-Pekka Junttila, Oulu (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: Nokia Corporation

(21) Appl. No.: 11/987,192

(22) Filed: Nov. 28, 2007

Related U.S. Application Data
(60) Provisional application No. 60/876,158, filed on Dec. 21, 2006.

(51) Int. Cl. H04M 11/04; H04Q 7/20

(52) U.S. Cl. 455/404.1; 455/452.1

(57) ABSTRACT

There are disclosed means, namely methods, apparatuses, network elements, systems and computer programs, for assigning, to a user equipment, a default bearer, and for assigning, to the user equipment, a dedicated special-purpose bearer such as an emergency bearer. According to exemplary implementations, the dedicated special-purpose bearer is assigned during network attachment of the user equipment or after network attachment of the user equipment, either in a preemptive or in an on-demand manner.

### CROSS REFERENCE TO RELATED APPLICATIONS

This application claims priority to provisional application Ser. No. 60/876,158 entitled EMERGENCY SERVICE IN A COMMUNICATION SYSTEM which was filed on Dec. 21, 2006, the contents of which are hereby incorporated by reference in its entirety.

### BACKGROUND OF THE INVENTION

### Field of the Invention

The present invention generally relates to an emergency service in a communication system. In particular, the present invention relates to providing an emergency service in a packet-switched domain of a communication system, especially an evolved mobile communication system.

The evolution of present-day mobile communication systems of the second to third generations (e.g. Global System for Mobile Communication GSM, Enhanced Data Rate for GSM Evolution EDGE, General Packet Radio Service GPRS, Universal Mobile Telecommunication System UMTS, and the like) is dealt with and promoted, among others, by the Third Generation Partnership Project (3GPP).

According to recent 3GPP standardization work, new network concepts and architectures are developed.

For near future deployment, an approach referred to as IP Multimedia Subsystem (IMS) is for example known. The IMS, which is for provision of IP (Internet Protocol) multimedia services comprising audio, video, text, chat, etc., as well as other near future approaches usually represent a further development, partially even a mixture, of present-day concepts. Hence, such approaches like IMS normally comprise a circuit-switched (CS) domain and a packet-switched (PS) domain. These two domains differ by the way they support user traffic in terms of circuit-switched or packet-switched connection types.

Naturally, besides conventional communication services, emergency scenarios, i.e. situations in which a user (or user equipment) is in an emergency and thus needs to initiate an emergency call, naturally represent a topic inherent in the framework of a communication systems. Therefore, concepts for providing emergency services are also under consideration for recent standardization approaches.

For the IP multimedia subsystem IMS, concepts for providing emergency services (emergency sessions) are defined in the technical specification “3GPP TS 23.167, V7.2.0” of September 2006. In this regard, it is defined that a user equipment being capable of circuit-switched connections shall use the CS domain for emergency services. That is, according to existing systems (including for example GSM/EDGE radio access network GERAN) a user equipment is assumed to effect an emergency network access using the CS domain.

Hence, it is a problem of existing systems that no solution exists for providing an emergency service in the PS domain, or even in a system not including a CS domain.

The above problem becomes essential in view of more far-reaching approaches of future communication systems, which go beyond present-day approaches such as Third Generation (3G) and/or high speed packet access (HSPA). A target of suchlike approaches is to develop a framework of an evolution of radio access technology towards high data rate, low latency and packet-optimized radio access technology, including to enable an all-IP system that efficiently transmits IP data. Accordingly, such evolved systems do not even comprise a CS domain any more, but only a PS domain which is both for voice (i.e. voice-over-IP, VoIP) calls and data calls. Suchlike approaches are currently known as, for example, system architecture evolution (SAE), long-term evolution (LTE) and/or evolved universal terrestrial radio access network (EUTRAN).

As regards emergency considerations, a user equipment of such an evolved system must, in the absence of CS domain, establish an emergency connection in the PS domain. Yet, no concepts to this end are available so far.

Furthermore, another problem again results from the above-mentioned fact that evolved (SAE/LTE/EUTRAN) systems will support only packet services. As no CS voice calls including CS-based emergency calls are possible, and thus VoIP is used for voice calls, emergency calls (and/or data transmitted) do in principle not differ from other calls, e.g. from data calls providing conventional communication services. Rather, all calls are represented by IP data, regardless of their content/purpose.

Accordingly, it is another problem that such evolved systems do not enable a separation between emergency calls/requests and other types of service calls/requests (like normal VoIP calls). In consequence, there is no means for prioritizing emergency calls over non-emergency calls, which is however required for a fast and efficient handling of emergency services.

Thus, for providing an emergency service in a packet-switched domain of a communication system, a solution to the above problems and drawbacks is needed.

### SUMMARY OF THE INVENTION

Hence, it is an object of the present invention for example that it may remove at least some of the above problems and to provide a solution for emergency services in evolved communication systems.

According to a first aspect of the present invention, a method includes requesting an attachment of a user equipment to a network, assigning, to the user equipment, a default bearer for a communication service, and assigning, to the user equipment, a dedicated special-purpose bearer for an emergency service. The special-purpose bearer is assigned to handle special-purpose communication services which are not handled by the default bearer.

According to a second aspect of the present invention, an apparatus includes a first radio assignment unit configured to assign to a user equipment a default radio bearer for a communication service, and a second radio assignment unit configured to assign to the user equipment a dedicated special-purpose radio bearer for an emergency service. The special-purpose radio bearer is assigned to handle special-purpose communication services which are not handled by the default radio bearer.

According to a third aspect of the present invention, an apparatus includes a first access assignment unit configured to assign, to a user equipment, a default access bearer for a communication service, and a second access assignment unit configured to assign, to the user equipment, a dedicated special-purpose access bearer for an emergency service. The special-purpose access bearer is assigned to handle special-purpose communication services which are not handled by the default access bearer.

According to a fourth aspect of the present invention, a system includes a user equipment, a first network element configured to assign, to the user equipment, a default radio bearer for a communication service, and to assign, to the user equipment, a dedicated special-purpose radio bearer for an emergency service, wherein the special-purpose radio bearer is assigned to handle special-purpose communication services a second network element configured to assign, to the user equipment, a default access bearer for a communication service, and to assign, to the user equipment, a dedicated special-purpose access bearer for an emergency service. The special-purpose access bearer is assigned to handle special-purpose communication services which are not handled by the default access bearer, and the system further includes a connection unit configured to establish a special-purpose connection between the user equipment and at least one of the first and second network elements using at least one of the default radio bearer and the default access bearer.

According to a fifth aspect of the present invention a computer program embodied on a computer readable medium provides assigning, to a user equipment, a default bearer for a communication service, and assigning, to the user equipment, a dedicated special-purpose bearer for an emergency service. The special-purpose bearer is assigned to handle special-purpose communication services which are not handled by the default bearer.

According to a sixth aspect of the present invention, an apparatus includes a default radio bearer assigning means for assigning, to a user equipment, a default radio bearer for a communication service, and dedicated special-purpose radio bearer assigning means for assigning, to a user equipment, a dedicated special-purpose radio bearer for an emergency service. The special-purpose radio bearer is assigned to handle special-purpose communication services which are not handled by the default radio bearer.

According to a seventh aspect of the present invention, an apparatus includes a default access bearer assigning means for assigning, to a user equipment, a default access bearer for a communication service, and dedicated special-purpose access bearer assigning means for assigning, to the user equipment, a dedicated special-purpose access bearer for an emergency service. The special-purpose access bearer is assigned to handle special-purpose communication services which are not handled by the default access bearer.

According to a further aspect of the present invention, the above object may for example be accomplished by a computer program, circuit arrangement or the like for carrying out a method according to an aspect of the present invention and/or for operating an apparatus (or network element) according to an aspect of the present invention to carry out the respective methods.

Embodiments of the present invention allow to establish a dedicated special-purpose (e.g. emergency) session in the packet-switched (PS) domain of a communication system.

Further, embodiments of the present invention allow to assign a dedicated special-purpose bearer for certain (e.g. critical) services, such as for example an emergency bearer for an emergency service. Thus, it may be ensured that network resources are always available for emergency services.

Further, embodiments of the present invention allow to separate a dedicated special-purpose (e.g. emergency) service from other types of services.

Further, embodiments of the present invention allow to prioritize a dedicated special-purpose (e.g. emergency) service over other types of services. In this regard, a dedicated bearer mechanism may be used to give appropriate priority to an emergency connection by assigning a specific high priority bearer for emergency purposes.

Further, embodiments of the present invention may be applied both to a case where it is mandatory that user equipments support dedicated PS (e.g. emergency) services and to a case where this is not mandatory, but each user equipment may indicate its capability of supporting such dedicated PS (e.g. emergency) services.

By virtue of embodiments of the present invention, it is simpler and faster both for a user equipment and a network to establish required special-purpose (e.g. emergency) connections. That is, the specifically assigned dedicated bearer facilitates identification and prioritization of such (e.g. emergency) connections.

Embodiments of the present invention are applicable to different interfaces, in particular an interface between a user equipment and a network node (e.g. a kind of Node_B having radio resource management functionality) and an interface between that network node and a gateway node having mobility management functionality (e.g. an access gateway).

Embodiments of the present invention are applicable to communication systems in accordance with any one of system architecture evolution, SAE, long-term evolution, LTE, and/or evolved universal terrestrial radio access network, EUTRAN.

### BRIEF DESCRIPTION OF THE DRAWINGS

In the following, the present invention will be described in greater detail with reference to the accompanying drawings, in which

FIG. 1 shows a signaling diagram of a method according to an embodiment of the present invention,

FIG. 2 shows a schematic block diagram of a structural arrangement according to an embodiment of the present invention, which is adapted for the method according to FIG. 1,

FIG. 3 shows a signaling diagram of a method according to an embodiment of the present invention,

FIG. 4 shows a schematic block diagram of a structural arrangement according to an embodiment of the present invention, which is adapted for the method according to FIG. 3,

FIG. 5 shows a signaling diagram of a method according to an embodiment of the present invention, and

FIG. 6 shows a schematic block diagram of a structural arrangement according to an embodiment of the present invention, which is adapted for the method according to FIG. 5.

### DETAILED DESCRIPTION OF EMBODIMENTS

The present invention is described herein with reference to particular non-limiting examples. A person skilled in the art will appreciate that the invention is not limited to these examples, and may be more broadly applied.

In particular, the present invention is described in relation to an example of 3GPP network specifications, especially to SAE, LTE and/or EUTRAN network concepts. Furthermore, an emergency service is taken as an example for the subsequent description. As such, the description of the embodiments given herein specifically refers to terminology which is directly related thereto. Although the present invention is particularly beneficial for deployment in such systems, such terminology is only used in the context of the presented examples, and does not limit the invention in any way.

Rather, the principles of the present embodiments are equally applicable to other systems and to other services, as long as underlying considerations and/or conditions are comparable to those of the described examples.

According to certain embodiments of the present invention, a dedicated emergency bearer may be assigned to a user equipment during (initial) network attachment thereof in a preemptive manner.

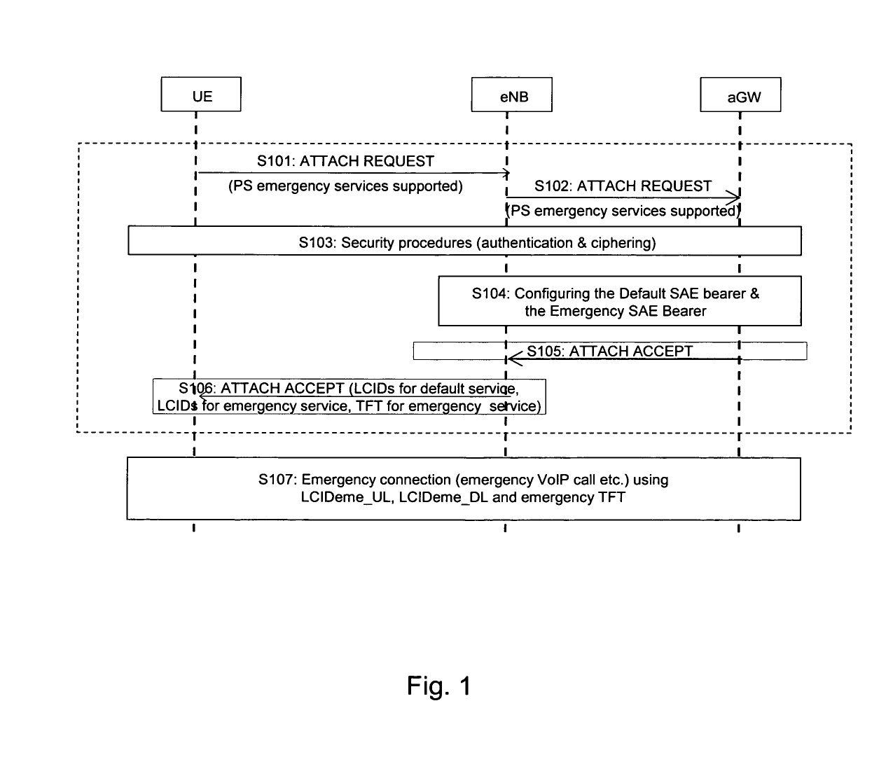

FIG. 1 shows a signaling diagram of a method according to an embodiment of the present invention. In the thus depicted method, there are involved a user equipment UE, a network element denoted by eNB (for evolved Node_B) and a network element denoted by aGW (for access gateway). Thereby, the network elements eNB and aGW represent a network of a communication system, to which the user equipment UE is registered and about to attach. The basic functions of the involved entities are essentially those as specified in corresponding specifications of an underlying communication system, e.g. SAE, LTE, EUTRAN.

It is to be noted that only those procedures and signaling flows are illustrated in FIG. 1, which are related to embodiments of the present invention. For example, an establishment of a radio connection between the user equipment UE and the network element aGW (including a random access channel procedure and a cell association procedure, for example), on which radio connection the messages of the illustrated steps are exchanged, is omitted for the sake of clarity.

In step S101 of FIG. 1, the user equipment UE, at an initial access to the network, sends an attachment/registration request message exemplarily denoted by ATTACH REQUEST to the network. In particular, this request may be sent to the network element eNB having radio resource management functionality. The eNB does however not handle the request itself. It rather forwards the request to the network element aGW having mobility management functionality (step S102). The aGW then handles the request, for example the aGW requests the eNB to reserve resources for a default bearer and for an emergency bearer.

The bearer handling is for example done such that a network element eNB configures the radio part, i.e. SAE radio bearer, and a network element aGW configures the access part, i.e. SAE access bearer. These two together (SAE radio bearer and SAE access bearer) thus form the SAE bearer.

According to an example implementation (which also applies to the other embodiments of the present invention), the attachment request message may contain an indication whether or not the user equipment supports packet-switched (PS) emergency services (and wants to have a dedicated bearer for emergency services). In FIG. 1, such an indication is illustrated in an affirmative sense, i.e. the UE supports PS emergency services and wants to have a dedicated emergency bearer. According to another example implementation (which is not shown, but also applies to the other embodiments of the present invention), support of PS emergency services is mandatory for the user equipments of the system. In that case, a respective indication of the user equipment requesting network attachment may not be needed. Rather, a PS emergency bearer would be assigned for any user equipment.

Upon receipt of the attachment request message from the requesting user equipment UE via the network element eNB, the network element aGW initiates security procedures including authentication and ciphering (step S103). The security procedures of step S103 are conventional ones and are performed between all three involved entities.

Thereafter, still during network attachment (which is indicated by a broken line box in FIG. 1) the network (i.e. the network elements eNB and aGW in cooperation) assign both a default SAE bearer and a dedicated emergency SAE bearer in parallel. The default and emergency bearer assignments include accepting of the attachment request by the aGW and configuring these bearers in step S104, sending an attachment acceptance message (e.g. ATTACH ACCEPT) from the aGW to the eNB in step S105 as well as effecting the assignments by means of a message transmission in step S106.

In step S104 of the embodiment according to FIG. 1, the network element eNB (in cooperation with the network element aGW) assigns a default SAE bearer by configuring an uplink logical channel (LCIDdef_UL: default bearer uplink logical channel identifier), a downlink logical channel (LCIDdef_DL: default bearer downlink logical channel identifier), and an access point name (APN) together with an IP address of the requesting user equipment UE. Also in step S104, i.e. in parallel to the default SAE bearer assignment, the network assigns a dedicated emergency SAE bearer by configuring an uplink logical channel (LCIDeme_UL: emergency bearer uplink logical channel identifier), a downlink logical channel (LCIDeme_DL: emergency bearer downlink logical channel identifier), and a traffic flow template (TFT) for emergency access/service.

In step S105 of FIG. 1, the network element aGW sends an attachment acceptance message to the network element eNB, which is exemplarily denoted by ATTACH ACCEPT. The eNB adds the previously configured radio bearer parameters to the acceptance message, and forwards it in step S106 to the requesting user equipment UE. In this message, configuration parameters of the bearers are transmitted, i.e. LCIDs for the default service/bearer, LCIDs for the emergency service/bearer, and the TFT for the emergency service/bearer. Thereby, the assignment of the default SAE bearer and the dedicated SAE emergency bearer is finally effected.

Although not illustrated herein, another example for an implementation of the bearer configuration and attachment acceptance procedures between the eNB and the aGW (i.e. steps S104 and S105 of FIG. 1) is that the aGW concatenates the bearer setup and the sending of the message ATTACH ACCEPT. That is, instead of two separate steps as exemplarily illustrated in FIG. 1, these two procedures may also be accomplished within a single step (i.e. the message ATTACH ACCEPT may be sent inside a bearer setup message from the aGW to the eNB).

Although not illustrated herein, another example for an implementation of the forwarding of the attachment acceptance from the eNB to the UE (i.e. step S106 of FIG. 1) is that the eNB builds a Radio Bearer Setup message (after receiving the bearer setup and ATTACH ACCEPT message from the aGW). In this case, the ATTACH ACCEPT message as illustrated in FIG. 1 would be included in the respective Radio Bearer Setup message (i.e. Radio Bearer Setup and ATTACH ACCEPT may be concatenated). Instead of the ATTACH ACCEPT message according to FIG. 1, the Radio Bearer setup message containing the ATTACH ACCEPT message is then sent from the eNB to the UE.

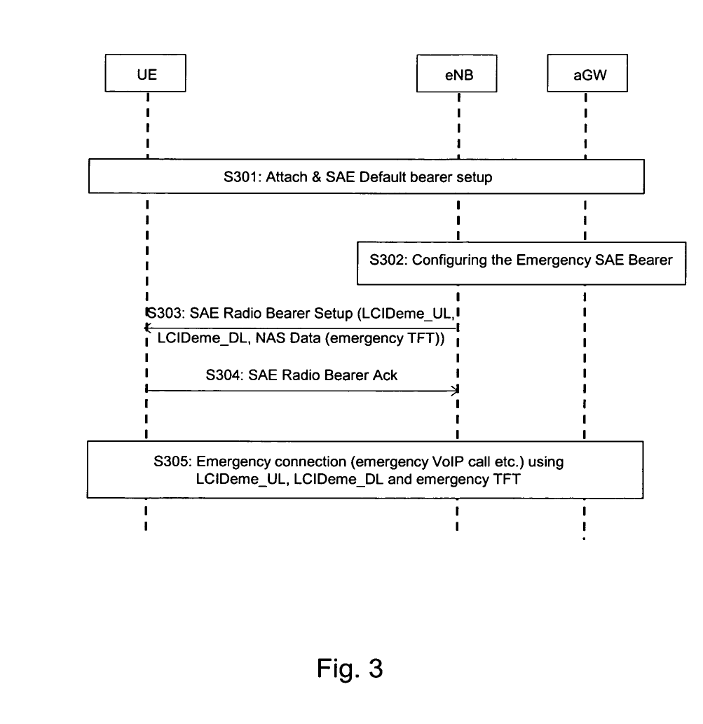

It is to be noted that the radio bearer part of the default bearer can also be given in separate “SAE Radio Bearer Setup” message (cf. FIG. 3). That is, it is not necessarily included in the attach accept message of step S106.

In consequence, upon completion of the network attachment procedure of the requesting user equipment, both a default bearer and a dedicated emergency bearer are assigned to the requesting user equipment.

Therefore, the user equipment UE is enabled to establish a dedicated special-purpose connection such as an emergency connection between the user equipment and the network using the assigned dedicated emergency bearer, i.e. its configured parameters (step S107). Such an emergency connection may for example be a voice (i.e. VoIP) call or an IP data call. As each bearer (including each emergency bearer comprises a respective pair of a radio bearer and an access bearer, it may be considered that the link UE-eNB is established by use of the radio bearer part and the link eNB-aGW is established by use of the access bearer part.

For the emergency bearer and the default bearer appropriate priorities are set by the network (not shown) such that the emergency bearer is prioritized higher than the default or any other bearer.

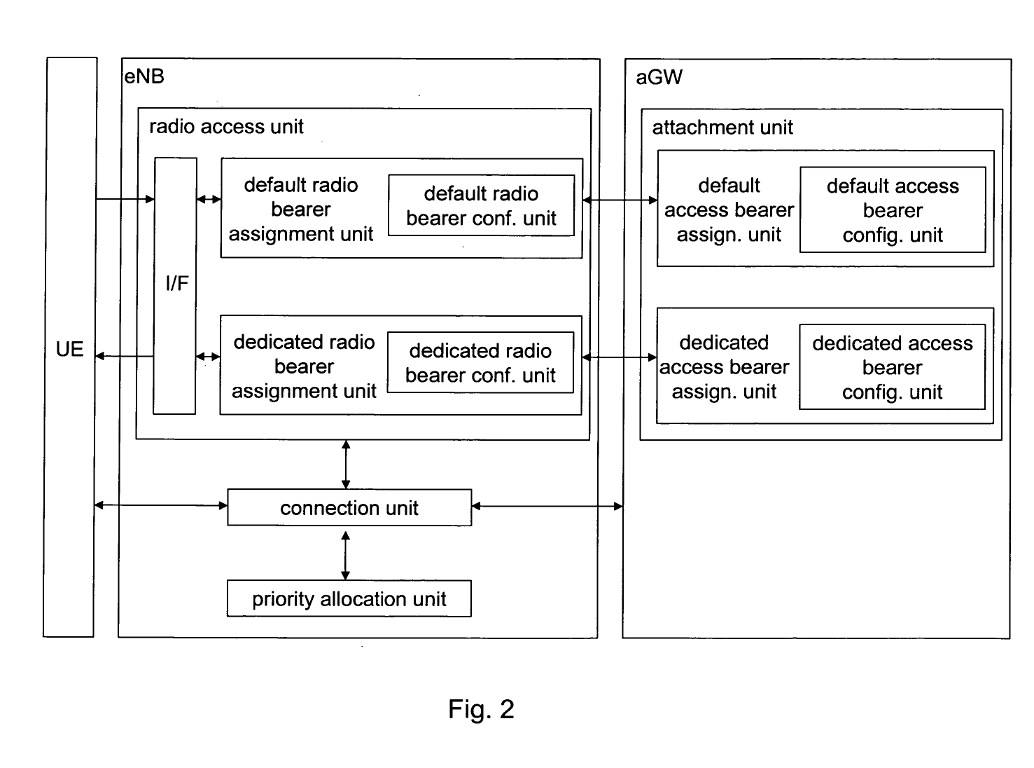

FIG. 2 shows a schematic block diagram of a structural arrangement according to an embodiment of the present invention, which is adapted for the method according to FIG. 1. Namely, FIG. 2 schematically illustrates an apparatus (or network element) eNB and an apparatus (or network element) aGW according to an embodiment of the present invention. It may also be understood that FIG. 2 schematically illustrates a system according to an embodiment of the present invention, wherein such a system may comprise a combination of UE and eNB as well as a combination of UE and eNB and aGW.

It is further to be noted that FIG. 2 shows an example embodiment, and an apparatus or system according to the present invention does not have to contain all of the functional blocks shown in FIG. 2. The arrows between the functional blocks and entities are intended to illustrate the signal flow. Hence, a plurality of connecting arrows between UE and eNB or between eNB and aGW does not necessarily mean that several (physical) connections exist there-between.

According to the embodiment of FIG. 2, a network element eNB for configuring an SAE radio bearer comprises a radio access unit which handles a radio bearer part of a network attachment procedure of a requesting user equipment UE. The radio access unit comprises a first assignment unit for default radio bearer assignment, which includes a default radio bearer configuration unit, and a second assignment unit for dedicated radio bearer (i.e. emergency radio bearer) assignment, which includes a dedicated (i.e. emergency) radio bearer configuration unit. It further comprises an interface unit denoted by I/F, which interfaces between the first and second assignment units and the outside of the network element eNB. The interface unit I/F further accounts for central processing capabilities of the radio access unit, including for example security procedures of step S103 of FIG. 1.

According to the embodiment of FIG. 1, a network element aGW for configuring an SAE access bearer comprises an attachment unit which handles an access bearer part of the network attachment procedure. The attachment unit comprises a first assignment unit for default access bearer assignment, which includes a default access bearer configuration unit, and a second assignment unit for dedicated access bearer (i.e. emergency access bearer) assignment, which includes a dedicated (i.e. emergency) access bearer configuration unit.

An attachment request message from the user equipment UE arrives at the interface unit I/F of the radio access unit of the network element eNB. From there, the process advances to the default radio bearer assignment unit which assigns a default SAE radio bearer, which includes configuration thereof (step S105 of FIG. 1), which is performed in cooperation between the default radio bearer configuration unit and the access gateway element aGW. In this regard, the network element aGW, in particular the default access bearer assignment/configuration unit, is for configuring a default SAE access bearer. In parallel to default radio bearer assignment, the process also advances to the emergency radio bearer assignment unit which assigns a dedicated emergency SAE radio bearer, which includes configuration thereof (step S105 of FIG. 1), which is performed in cooperation between the emergency radio bearer configuration unit and the access gateway element aGW. In this regard, the network element aGW, in particular the emergency access bearer assignment/configuration unit, is for configuring an emergency SAE access bearer. Then, the two bearers (each including radio bearer part and access bearer part) are assigned and the assignment is effected by sending an attachment acceptance message from the network element aGW to the network element eNB, and from there (i.e. I/F) to the user equipment (steps S105 and S106 of FIG. 1). Thereupon, an emergency connection may be established using the assigned emergency SAE bearer. To this end, a connection unit of the network element eNB is used, which interconnects the user equipment UE, the network element eNB and the access gateway element aGW. For getting knowledge about the assigned bearers, the connection unit is connected with the radio access unit. And for getting knowledge about priority levels of the assigned bearers, the connection unit is connected with a priority allocation unit, which allocates a first priority level to the assigned default bearer and a second priority level to the assigned dedicated special-purpose bearer in such a manner that the second priority level (of the emergency bearer) is higher than the first priority level (of the default bearer).

According to certain embodiments of the present invention, a dedicated emergency bearer may be assigned to a user equipment after (initial) network attachment thereof in a preemptive manner.

FIG. 3 shows a signaling diagram of a method according to an embodiment of the present invention. As regards the involved entities, the same as set out in connection with FIG. 1 applies accordingly.

Similar to FIG. 1, FIG. 3 does also illustrate only those procedures and signaling flows which are related to embodiments of the present invention. Other procedures and signaling flows, such as an establishment of a radio connection between the user equipment UE and the network element aGW are omitted for the sake of clarity.

In step S301 of FIG. 3, a network attachment of the user equipment UE is performed and a default SAE bearer (including radio bearer and access bearer) is assigned to the user equipment UE. These procedures are initiated by an attachment request message like that of FIG. 1 (which may again contain an indication that the user equipment supports packet-switched (PS) emergency services and wants to have a dedicated bearer for emergency services). The step S301 basically comprises procedures which are similar to those of steps S101 through S106, however only for default bearer assignment.

According to the embodiment of FIG. 3, only upon completion of the network attachment and the default bearer assignment, a dedicated emergence bearer assignment is started. The subsequent separate emergency bearer setup procedure according to FIG. 3 again comprises configuring of the dedicated emergency SAE bearer including LCIDeme_UL, LCIDeme_DL and TFT for emergency access/service in step S302 of FIG. 3 and an effecting of the assignment by means of a message transmission to the requesting user equipment UE in step S303 of FIG. 3. However, in this case, the emergency bearer assignment in step S303 is not effected by means of an attachment acceptance message (which has already been sent to the UE in step S301), but by means of a radio bearer setup message. Parameters of this message may include the LCIDs for the emergency service/bearer, and the TFT for the emergency service/bearer, as configured in step S302. According to an implementation detail, the emergency traffic flow template (TFT) is transmitted as NAS (Non-Access Stratum) data of a NAS packet data unit.

Upon receipt of the radio bearer setup, the user equipment may respond by sending an acknowledgement to the network element eNB (step S304 of FIG. 3), thus completing emergency bearer assignment according to the illustrated embodiment.

As regards establishment of an emergency connection (step S305 of FIG. 3) and prioritization of the default and emergency bearers, the same as set out in connection with FIG. 1 applies accordingly.

Although no distinction between radio bearer part and access bearer part is made in connection with FIG. 3, the same or similar explanations as made above in connection with FIG. 1 apply here as well.

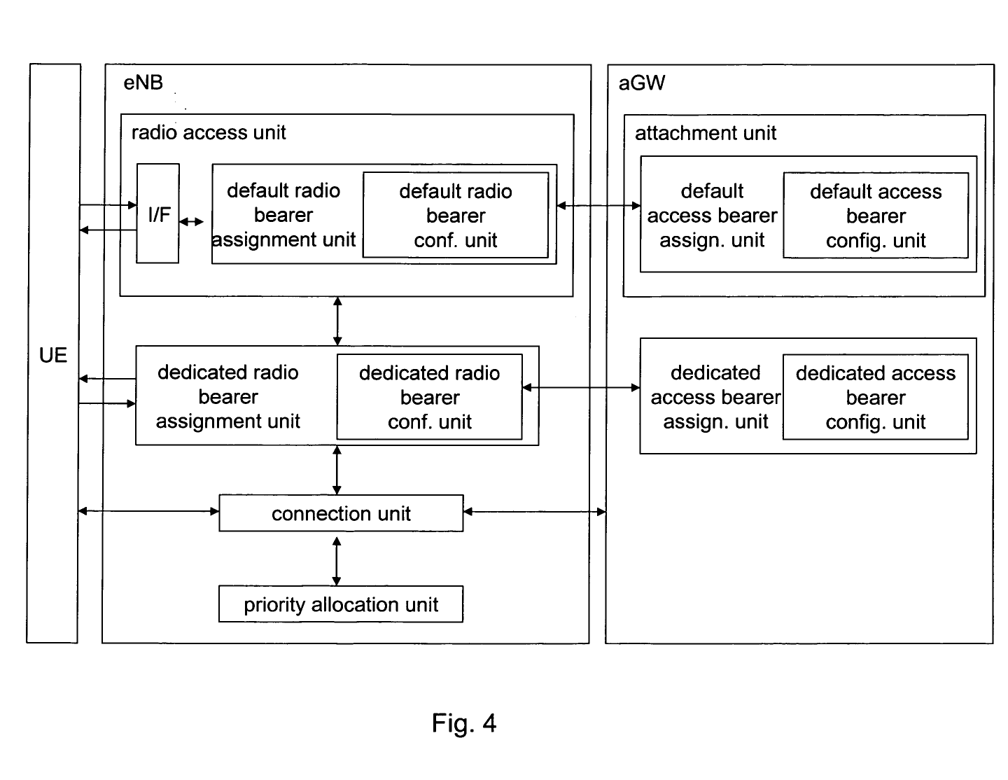

FIG. 4 shows a schematic block diagram of a structural arrangement according to an embodiment of the present invention, which is adapted for the method according to FIG. 3. Namely, FIG. 4 schematically illustrates an apparatus (or network element) eNB and an apparatus (or network element) aGW according to an embodiment of the present invention. It may also be understood that FIG. 4 schematically illustrates a system according to an embodiment of the present invention, wherein such a system may comprise a combination of UE and eNB as well as a combination of UE and eNB and aGW.

Basically, in response to the fact that emergency bearer assignment is performed in a separate setup procedure after completion of network attachment, the apparatus (or network element) eNB of FIG. 4 differs from that of FIG. 2 in that the emergency radio bearer assignment unit is not longer associated with/included in the radio access unit. Rather, the emergency radio bearer assignment unit according to the present embodiment is functionally independent from the radio access unit.

Similarly, the apparatus (or network element) eNB of FIG. 4 differs from that of FIG. 2 in that the emergency access bearer assignment unit is not longer associated with/included in the attachment unit. Rather, the emergency access bearer assignment unit according to the present embodiment is functionally independent from the attachment unit.

This mainly results in that the radio access unit of the network element eNB, after completion of the network attachment and the default bearer assignment, notifies the (dedicated) emergency radio bearer assignment unit, which then starts the separate emergency radio bearer setup in cooperation with the access gateway element aGW and the user equipment UE (cf. steps S302, S303 and S304 of FIG. 3). In this regard, the network element aGW, in particular the default access bearer assignment/configuration unit, is for configuring an emergency SAE access bearer accordingly.

Notwithstanding the above structural differences between the present embodiment and that according to FIG. 2, the functions of the individual functional blocks are rather similar to those described in connection with FIG. 2. The differing signal flow also becomes apparent from the differences in the signaling diagrams of FIGS. 1 and 3.

As regards the connection unit and the priority allocation unit, the same or similar notions as set out in connection with FIG. 2 apply accordingly to the present embodiment.

According to certain further embodiments of the present invention, a dedicated emergency bearer may be assigned to a user equipment after network attachment thereof in an on-demand manner. That is, according to these embodiments, a dedicated (emergency) bearer is setup only when an emergency call is initiated by a user equipment.

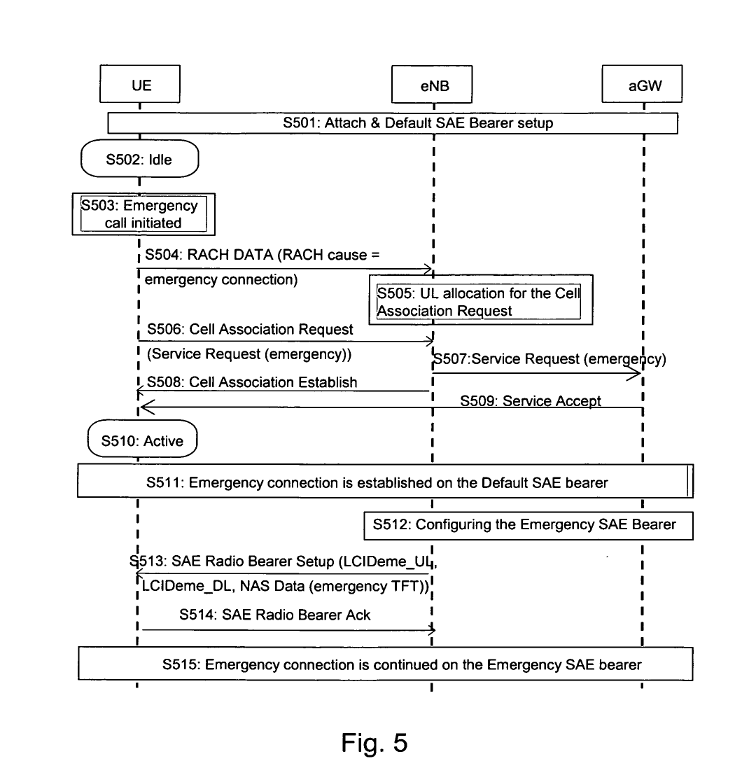

FIG. 5 shows a signaling diagram of a method according to an embodiment of the present invention. As regards the involved entities, the same as set out in connection with FIG. 1 applies accordingly.

Similar to FIGS. 1 and 3, FIG. 5 does also illustrate only those procedures and signaling flows which are related to embodiments of the present invention. Other procedures and signaling flows, such as an establishment of a radio connection between the user equipment UE and the network element aGW are omitted for the sake of clarity.

In step S501 of FIG. 5, a network attachment of the user equipment UE is performed and a default SAE bearer is assigned to the user equipment. These procedures are initiated by an attachment request message like that of FIG. 1 (which may again contain an indication that the user equipment supports packet-switched (PS) emergency services and wants to have a dedicated bearer for emergency services). The step S501 basically comprises procedures which are similar to those of steps S101 through S104, however only for default bearer assignment.

Accordingly, step S501 of FIG. 5 is comparable to step S301 of FIG. 3. However, in contrast to the embodiment according to FIG. 3, the present embodiment does not automatically proceed to emergency bearer setup, when network attachment and default bearer assignment are completed. Rather, according to the present embodiment, no preemptive emergency bearer setup is performed.

An assignment of a dedicated special-purpose bearer, i.e. an emergency bearer, is only performed upon demand of the user equipment after completion of its network attachment. Hence, the present process of emergency bearer setup is started when the user equipment UE initiates, starting from its idle mode of step S502, an emergency call in step S503.

As is exemplarily illustrated by FIG. 5, an emergency call is started by the user equipment UE by way of initiating a random access channel (RACH) procedure in step S504 in order to move to active state and to get a cell radio network temporary identifier (C-RNTI) from the network. To this end, an RACH DATA message is sent from the user equipment UE to the network element eNB, which contains as parameter that RACH cause is an emergency connection. From this information, the network element eNB may see that this is a request of high priority and handle it accordingly. Upon receipt of the RACH message, a cell association procedure is performed between the user equipment UE and the network element eNB. In detail, according to the illustrated embodiment, the cell association procedure may comprise an uplink allocation for the cell association request by the network element eNB (step S505), a sending of a cell association request from the user equipment UE to the network element eNB, which request contains a service request indicating emergency as requested service (step S506), a handling of the cell association request at the network element eNB (not shown in FIG. 5), a sending of the respective emergency service request from the network element eNB to the network element aGW (step S507), a sending of a cell association establishment message from the network element eNB to the user equipment UE (step S508), and a sending of a service acceptance message from the network element aGW to the user equipment UE (step S509). In response thereto, the user equipment UE moves to active mode in step S510. Thereby, an emergency connection between the user equipment UE, the network element eNB and the access gateway element aGW is established using the previously (in step S501) assigned default SAE bearer.

In summary, steps S504 through S511 of FIG. 5 constitute an establishment of an emergency connection on the default SAE bearer.

After the special-purpose connection establishment, i.e. after start of the emergency connection on the default bearer, a separate dedicated emergency bearer setup procedure is started during the ongoing emergency connection, which is comparable to that of the embodiment according to FIG. 3.

That is, steps S512 through S515 of FIG. 5 are comparable to steps S302 through S305 of FIG. 3. Therefore, a detailed description thereof is omitted and reference is made to the description in connection with FIG. 3.

In contrast to the embodiment shown in FIG. 3, according to the present embodiment, an emergency connection is not established in step S515 (like in step S305 of FIG. 3), but the already existing emergency connection of step S511 is continued on a different bearer. Namely, during the ongoing connection, the emergency connection originally established on the previously assigned default bearer is changed, upon completion of its assigning, to the newly assigned emergency bearer. Stated in other words, the emergency connection first uses default bearer parameters, i.e. LCIDdef_UL, LCIDdef_DL, UE's IP address and APN (e.g. packet data protocol address), etc., and after continuation on the special-purpose bearer, the emergency connection uses dedicated emergency bearer parameters, i.e. LCIDeme_UL, LCIDeme_DL and emergency TFT.

As regards prioritization of the default and emergency bearers, the same as set out in connection with FIG. 1 applies accordingly.

Although another case is exemplified above, it is noted that the above-mentioned RACH procedure and cell association procedure also apply for cases where the emergency bearer already exists and the user equipment is in idle state.

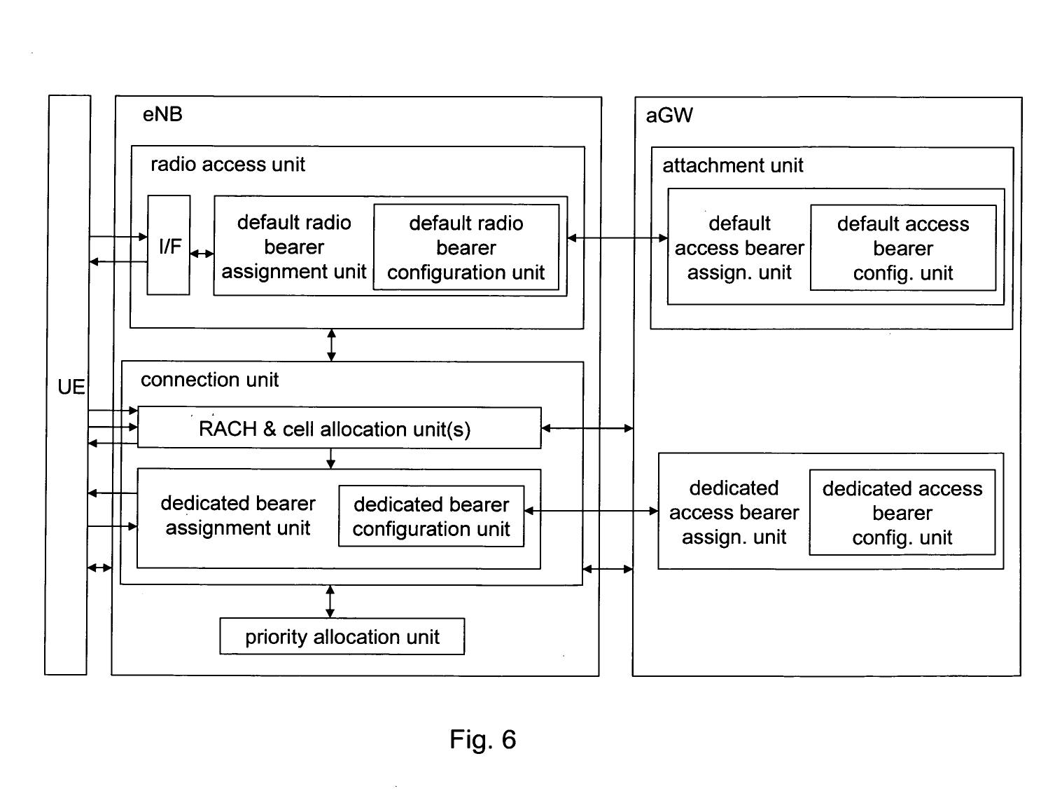

FIG. 6 shows a schematic block diagram of a structural arrangement according to an embodiment of the present invention, which is adapted for the method according to FIG. 5. Namely, FIG. 6 schematically illustrates an apparatus (or network element) eNB and an apparatus (or network element) aGW according to an embodiment of the present invention. It may also be understood that FIG. 6 schematically illustrates a system according to an embodiment of the present invention, wherein such a system may comprise a combination of UE and eNB as well as a combination of UE and eNB and aGW.

Basically, in response to the fact that emergency bearer assignment is performed in a separate setup procedure after establishment of an emergency connection on a default bearer, the apparatuses (or network elements) eNB and aGW of FIG. 6 differ from those of FIGS. 2 and 4.

Namely, a dedicated (i.e. emergency) radio bearer assignment unit according to the present embodiment is neither associated with/included in a radio access unit, such as according to FIG. 2, nor arranged independently of a radio access unit and a connection unit, such as according to FIG. 4. Rather, a dedicated (i.e. emergency) radio bearer assignment unit according to the present embodiment is associated with/included in a connection unit according to the present embodiment.

Similarly, an emergency access bearer assignment unit of the network element aGW is not longer associated with/included in the attachment unit. Rather, the emergency access bearer assignment unit according to the present embodiment is functionally independent from the attachment unit, and is connected with the emergency radio bearer assignment unit of the network element eNB.

Similar to the embodiment according to FIG. 4, a radio access unit of the network element eNB according to the present embodiment comprises a default radio bearer assignment unit including a default radio bearer configuration unit performing for a radio bearer part of a network attachment of a requesting user equipment UE. The radio access unit similarly comprises an interface unit denoted by I/F, which interfaces between the default radio bearer assignment unit and the outside of the network element eNB, in particular with the UE. The interface unit accounts for central processing capabilities of the radio access unit, including for example security procedures. An attachment unit of the network element aGW according to the present embodiment comprises an emergency access bearer assignment unit including an emergency access bearer configuration unit. Accordingly, the radio access unit of the network element eNB, in cooperation with UE and aGW, handles the processing according to step S501 of FIG. 5.

After completion of the network attachment and the default bearer assignment, the attachment unit notifies the connection unit according to the present embodiment, which establishes a default connection between the user equipment and the network on the assigned default bearer. When an emergency connection as an example of a dedicated special-purpose connection is initiated by the user equipment UE (cf. step S503 of FIG. 5), the connection unit in cooperation with the aGW handles an emergency connection establishment between the user equipment and the network on the assigned default bearer (cf. steps S504 through S511 of FIG. 5). For this purpose, the connection unit according to the present embodiment comprise a random access channel unit for performing a random access channel (RACH) procedure between the network element eNB and the user equipment UE for emergency access, and a cell allocation unit for performing a cell association procedure between the network element eNB and the user equipment UE for emergency connection. According to FIG. 6, these units are exemplarily illustrated by a single block within the present connection unit, which does however not exclude that these units are arranged separately from each other.

Upon establishment of an emergency connection on a default bearer by the connection unit, in particular by the RACH & cell allocation unit(s), a dedicated (i.e. emergency) radio bearer assignment unit according to the present embodiment belonging to the connection unit according to the present embodiment is triggered to assign a dedicated special-purpose radio bearer. The thus triggered separate emergency bearer setup procedure of steps S512 through S515 is then performed by the emergency radio bearer assignment unit (including an emergency radio bearer configuration unit) according to the present embodiment in cooperation with the requesting user equipment UE and the access gateway element aGW, in particular the emergency access bearer assignment unit thereof. That is, the present emergency radio bearer assignment unit assigns the dedicated emergency radio bearer, and the present emergency access bearer assignment unit assigns the dedicated emergency access bearer, after said emergency connection establishment on the previously assigned default bearer. Upon completion of the assignment of the dedicated emergency bearer (including radio bearer and access bearer), the connection unit causes the ongoing emergency connection between the user equipment UE and the network eNB/aGW to continue on the assigned dedicated emergency bearer (cf. step S515 of FIG. 5).

Notwithstanding the above structural differences between the present embodiment and those according to FIGS. 2 and 4, the functions of the individual functional blocks are rather similar to those described in connection with FIGS. 2 and 4. The differing signal flow becomes apparent from the differences in the signaling diagrams of FIGS. 1 and 3 as compared with FIG. 5.

As regards the connection unit and the priority allocation unit, the same or similar notions as set out in connection with FIG. 2 apply accordingly to the present embodiment.

Although described above with respect to certain terms such as user equipment UE, evolved Node_B eNB and access gateway element aGW, the present invention is not limited to devices and/or systems with this denomination. Rather, these terms merely serve for illustrative purpose. The present invention and all its aspects and options may as well be applied to any other terminal equipment and network elements providing similar or equivalent functions, regardless of their denominations.

It is also to be noted that the messages used in FIGS. 1, 3 and 5 are generally assumed to be known to a skilled person, and that the message names used these figures are merely intended as an example according to current specifications and/or working assumptions. Apart therefrom, any message with any name may be used instead, as long as the described functionality is achieved thereby.

In this regard, it is to be noted that specifics and details concerning connection establishment between user equipment and network (cf. steps S107, S305, S509 and S515) are omitted herein as they are not essential for the present invention. Therefore, the user equipment has been described as a single entity without addressing its internal structure in terms of different layer functions such as for example packet data convergence protocol PDCP, mobility management MM and/or radio resource control RRC. Further, specifics and details concerning contents of traffic flow templates have been omitted as these are not essential for the present invention, but are mainly directed to flow filtering and connection establishment between user equipment and network. In general, it is to be noted that a traffic flow template provides a mapping of traffic to a secondary packet data protocol (PDP) context if more than one PDP context is associated with a single PDP address.

Rather, such principles are disclosed in a parallel application entitled “Emergency support in a communication system” by the assignee of the present application, which has been filed at the same time.

Although the aspects of the present invention are described above mainly with respect to methods and structural arrangements of a network element exemplarily denoted by eNB, the present invention as a matter of course also covers respective user equipments UE and respective access gateway elements aGW, which are adapted to cooperate with the illustrated network elements eNB in order to implement the illustrated methods.

In detail, a user equipment according to the present invention may for example be configured to initiate a network attachment e.g. by sending an attachment request message with corresponding parameters as described above, to participate in security procedures, to receive an attachment acceptance message with corresponding parameters as described above, to participate in a default bearer setup and/or in a parallel/separate emergency bearer setup, to initiate an emergency call, to participate in RACH and cell association procedures, and/or to participate in an emergency connection using both a default bearer and/or a dedicated emergency bearer. A user equipment according to the present invention may thus comprise accordingly configured units, either as separate functional blocks or as integrated units realizing more than one of the above-mentioned functions. According to embodiments of the present invention, the user equipment may be used as a modern, i.e. applications using the user equipment UE are arranged in or running on a computer such as a personal computer PC to which the user equipment is connected. The user equipment UE may for example also be a terminal such a mobile phone or the like.

Further, a network element according to the present invention, which acts as an access gateway element aGW, may for example be configured to participate in network attachment of a user equipment, to participate in security procedures in this regard, to participate in a default bearer setup and/or in a separate emergency bearer setup, to participate in configuration of a default and/or an emergency bearer, and/or to participate in an emergency connection using both a default bearer and a dedicated emergency bearer. An access gateway node according to the present invention may thus comprise accordingly configured units, either as separate functional blocks or as integrated units realizing more than one of the above-mentioned functions.

Any methods and operations described above may of course be implemented by way of software and/or hardware.

In general, it is to be noted that respective functional elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

Generally, for the purpose of the present invention as described herein above, it should be noted that a communication device or terminal may for example be any device by means of which a user may access a network and/or a server of such network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals (Universal Mobile Telecommunication System) are particularly suitable for being used in connection with the present invention, nevertheless terminals conforming to standards such as GSM (Global System for Mobile communications) or IS-95 (Interim Standard 95) may also be suitable; networks referred to in this connection may comprise mobile and fixed network sections independent of the type of technology on which the networks are operated, for example those networks operate on the basis of the Internet Protocol IP, independent of the protocol version (IPv4 or IPv6), or on the basis of any other packet protocol such as User Datagram Protocol UDP, etc.

Devices can be implemented as individual devices, devices may also be implemented as a module configured to accomplish interoperability with other modules constituting an entire apparatus, e.g. a module device may be represented as a chipset or chip card e.g. insertable and/or connectable to an apparatus such as a mobile phone, or a module may be realized by executable code stored to a mobile phone or other device for execution upon invocation.

Thus, in view of the foregoing, it becomes clear that the present invention addresses several aspects of methods, elements, entities and modules, which are for example as follows. In this regard, it is to be noted that specific denominations are not intended to limit the scope of respective aspects and embodiments of the present invention in any way.

Furthermore, the present invention generally also comprises respective computer programs as well as circuit arrangements for carrying out the aspects of the methods and/or for operating hardware to carry out the aspects of the above methods.

In summary, in the terms of the above examples, an own dedicated (SAE) bearer comprising a radio bearer and an access bearer for emergency services is provided in an LTE network environment. This bearer either could be predefined or could be assigned during initial access and attach procedures or could be setup when an emergency connection is initiated. Network and user equipment are thus enabled to identify an emergency connection (like an emergency voice call) by using this dedicated emergency bearer, and thus the emergency connection could get an appropriately high priority.

As regards consumption of network resources, a preemptive emergency bearer setup according to certain embodiments of the present invention may be inefficient as network resources cannot be utilized unless an emergency call is actually made. In order to optimize network resource consumption, an emergency bearer setup according to present embodiments may for example be achieved by only performing a reservation in accordance with a specific emergency attachment, but not in a “normal” attachment. Another option could be to achieve an emergency bearer setup according to present embodiments by only making a QoS (quality of service) reservation, but actually not implementing a bearer for it, which is only done when necessary.

Essentially, there are thus disclosed means, namely methods, apparatuses, network elements, systems and computer programs, for assigning, to a user equipment, a default bearer, and for assigning, to the user equipment, a dedicated special-purpose bearer such as an emergency bearer. According to exemplary implementations, the dedicated special-purpose bearer is assigned during network attachment of the user equipment or after network attachment of the user equipment, either in a preemptive or in an on-demand manner.

Even though the invention is described above with reference to the examples according to the accompanying drawings, it is clear that the invention is not restricted thereto. Rather, it is apparent to those skilled in the art that the present invention can be modified in many ways without departing from the spirit and scope of the inventive idea as disclosed herein above.

We claim:

1. A method, comprising:
requesting an attachment of a user equipment to a network;
assigning, to the user equipment, a default bearer for a communication service; and
assigning, to the user equipment, a dedicated special-purpose bearer for an emergency service,
wherein the special-purpose bearer is assigned to handle special-purpose communication services which are not handled by said default bearer.

2. The method of claim 1, wherein the assigning the default bearer and the dedicated special-purpose bearer comprises:
assigning at least one radio bearer between said user equipment and a resource management apparatus, and
assigning at least one access bearer between said resource management apparatus and a mobility management apparatus.

3. The method of claim 1, further comprising:
allocating a first priority level to the assigned default bearer; and
allocating a second priority level to the assigned dedicated special-purpose bearer, wherein the second priority level is a greater priority level than the first priority level.

4. The method of claim 1, wherein assigning of a default bearer comprises:
configuring an uplink logical channel and downlink logical channel, and an access point name which comprises a packet data protocol address for the default bearer.

5. The method of claim 1, wherein assigning of a dedicated special-purpose bearer comprises:
configuring an uplink logical channel and downlink logical channel and a traffic flow template for the special-purpose bearer.

6. The method of claim 1, further comprising:
indicating from the user equipment to the network element that a dedicated special-purpose bearer is desired to be assigned.

7. The method of claim 1, further comprising:
establishing a special-purpose connection between the user equipment and the network using the assigned dedicated special-purpose bearer.

8. The method of claim 1, further comprising:
attaching the user equipment to the network,
wherein the assigning of the default bearer and the assigning of the dedicated special-purpose bearer are performed in parallel during network attachment of the user equipment.

9. The method of claim 8, wherein the assigning of the dedicated special-purpose bearer comprises using an attachment acceptance message sent from the network to the user equipment when assigning the dedicated special-purpose bearer.

10. The method of claim 1, further comprising:
attaching the user equipment to the network,
wherein the assigning of the default bearer is performed during network attachment of the user equipment, and the assigning of the dedicated special-purpose bearer is performed subsequently after completion of the network attachment of the user equipment.

11. The method of claim 10, wherein the assigning of the dedicated special-purpose bearer comprises using a bearer setup message sent from the network to the user equipment when assigning the dedicated special-purpose bearer.

12. The method of claim 1, further comprising:
attaching the user equipment to the network,
wherein the assigning of the default bearer is performed during network attachment of the user equipment, and the assigning of the dedicated special-purpose bearer is performed upon demand of the user equipment after completion of the network attachment.

13. The method of claim 12, wherein the assigning of the dedicated special-purpose bearer comprises using the previously assigned default bearer when assigning the dedicated special-purpose bearer.

14. The method of claim 12, further comprising:
establishing a special-purpose connection between the user equipment and the network using the assigned default bearer,
wherein the assigning of the dedicated special-purpose bearer is performed after establishment of said special-purpose connection.

15. The method of claim 14, wherein the establishing of the special-purpose connection comprises:
performing a random access channel procedure to establish a random access channel between the user equipment and the network, and
performing a cell association procedure to associate a cell between the user equipment and the network.

16. The method of claim 14, further comprising:
continuing the special-purpose connection between the user equipment and the network using the assigned dedicated special-purpose bearer upon completion of its assignment.

17. The method of claim 1, wherein the requesting a connection to a communication service from a user equipment comprises sending the request to a radio resource management node and/or a gateway node.

18. The method of claim 1, wherein the assigning of the default bearer and the special-purpose bearer are performed in a communication system in accordance with any one of system architecture evolution (SAE), long-term evolution (LTE), and/or evolved universal terrestrial radio access network (EUTRAN).

19. An apparatus, comprising:
a first radio assignment unit configured to assign to a user equipment a default radio bearer for a communication service; and
a second radio assignment unit configured to assign to the user equipment a dedicated special-purpose radio bearer for an emergency service,
wherein the special-purpose radio bearer is assigned to handle special-purpose communication services which are not handled by said default radio bearer.

20. The apparatus according to claim 19, further comprising:
a priority allocation unit configured to allocate a first priority level to the assigned default radio bearer and a second priority level to the assigned dedicated special-purpose radio bearer,
wherein the second priority level is a greater priority level than the first priority level.

21. The apparatus according to claim 19, wherein the first radio assignment unit comprises a first configuration unit configured to configure an uplink logical channel and a downlink logical channel for the default radio bearer.

22. The apparatus according to claim 19, wherein the second radio assignment unit comprises a second configuration unit configured to configure an uplink logical channel and a downlink logical channel for the dedicated special-purpose radio bearer.

23. The apparatus according to claim 19, further comprising:
a connection unit configured to establish a special-purpose connection between the apparatus and the user equipment using the dedicated special-purpose bearer assigned by the second radio assignment unit.

24. The apparatus according to claim 19, further comprising:
a radio access unit configured to perform radio access of the user equipment to a network,
wherein the first and second radio assignment units are further configured to assign the default radio bearer and the dedicated special-purpose radio bearer in parallel during radio access of the user equipment.

25. The apparatus according to claim 24, wherein the apparatus is further configured to assign the dedicated special-purpose radio bearer by sending an attachment acceptance message to the user equipment.

26. The apparatus according to claim 19, further comprising:
a radio access unit configured to perform radio access of the user equipment to a network,
wherein the first radio assignment unit is further configured to assign the default radio bearer during radio access of the user equipment, and the second radio assignment unit is further configured to assign the dedicated special-purpose radio bearer subsequently after completion of the radio access of the user equipment.

27. The apparatus according to claim 26, wherein a radio bearer setup message is sent from the apparatus to the user equipment when assigning the dedicated special-purpose radio bearer.

28. The apparatus according to claim 19, further comprising:
a radio access unit configured to perform radio access of the user equipment to a network,
wherein the first radio assignment unit is further configured to assign the default radio bearer during radio access of the user equipment, and the second radio assignment unit is further configured to assign the dedicated special-purpose radio bearer upon demand of the user equipment after completion of the radio access of the user equipment to the network.

29. The apparatus according to claim 28, wherein the apparatus is further configured to assign the dedicated special-purpose radio bearer using the previously assigned default radio bearer.

30. The apparatus according to claim 28, wherein the connection unit is further configured to establish a special-purpose connection between the apparatus and the user equipment using the assigned default radio bearer, and wherein the second radio assignment unit is further configured to assign the dedicated special-purpose radio bearer after establishment of said special-purpose connection.

31. The apparatus according to claim 28, wherein the connection unit further comprises:
a random access channel unit configured to perform a random access channel procedure to establish a random access channel between the apparatus and the user equipment, and
a cell allocation unit configured perform a cell association procedure to associate a cell between the apparatus and the user equipment.

32. The apparatus according to claim 28, wherein the connection unit is further configured to continue the special-purpose connection between the apparatus and the user equipment using the assigned dedicated special-purpose radio bearer upon completion of its assignment by the second radio assignment unit.

33. The apparatus according to claim 19, wherein the apparatus comprises or is comprised of a radio resource management node and/or is connected to a gateway node.

34. The apparatus according to claim 28, wherein the apparatus is configured to be applicable in a communication system in accordance with any one of system architecture evolution (SAE) long-term evolution (LTE), and/or evolved universal terrestrial radio access network (EUTRAN).

35. The apparatus according to claim 19, wherein the user equipment is a terminal device.

36. An apparatus, comprising:
a first access assignment unit configured to assign, to a user equipment, a default access bearer for a communication service, and
a second access assignment unit configured to assign, to the user equipment, a dedicated special-purpose access bearer for an emergency service,
wherein the special-purpose access bearer is assigned to handle special-purpose communication services which are not handled by said default access bearer.

37. The apparatus according to claim 36, wherein the first radio assignment unit comprises
a first configuration unit configured to configure an access point name which comprises a packet data protocol address for the default access bearer.

38. The apparatus according to claim 36, wherein the second radio assignment unit comprises
a second configuration unit configured to configure a traffic flow template for the dedicated special-purpose access bearer.

39. The apparatus according to claim 36, further comprising:
an attachment unit configured to attach the user equipment to a network,
wherein the first and second access assignment units are further configured to assign the default access bearer and the dedicated special-purpose access bearer in parallel during network attachment of the user equipment.

40. The apparatus according to claim 36, further comprising:
an attachment unit configured to attach the user equipment to a network,
wherein the first access assignment unit is further configured to assign the default access bearer during network attachment of the user equipment, and the second access assignment unit is further configured to assign the dedicated special-purpose access bearer subsequently after completion of the network attachment of the user equipment.

41. The apparatus according to claim 36, further comprising:
an attachment unit configured to attach the user equipment to a network,
wherein the first access assignment unit is further configured to assign the default access bearer during network attachment of the user equipment, and the second access assignment unit is further configured to assign the dedicated special-purpose access bearer upon demand of the user equipment after completion of the network attachment.

42. The apparatus according to claim 41, wherein the apparatus is further configured to assign the dedicated special-purpose access bearer using the previously assigned default access bearer.

43. The apparatus according to claim 36, wherein the apparatus comprises or is comprised of a gateway node.

44. A system, comprising:
a user equipment;
a first network element configured to assign, to the user equipment, a default radio bearer for a communication service, and to assign, to the user equipment, a dedicated special-purpose radio bearer for an emergency service, wherein the special-purpose radio bearer is assigned to handle special-purpose communication services;
a second network element configured to assign, to the user equipment, a default access bearer for a communication service, and to assign, to the user equipment, a dedicated special-purpose access bearer for an emergency service, wherein the special-purpose access bearer is assigned to handle special-purpose communication services which are not handled by said default access bearer; and
a connection unit configured to establish a special-purpose connection between the user equipment and at least one of the first and second network elements using at least one of the default radio bearer and the default access bearer.

45. The system of claim 44, wherein the connection unit configured to establish the special-purpose connection using at least one the default radio bearer and the default access bearer maintains the special-purpose connection using at least one of the special-purpose radio bearer and the special-purpose access bearer.

46. A computer program embodied on a computer readable medium, said computer program configured to control a processor to perform:
assigning, to a user equipment, a default bearer for a communication service; and
assigning, to the user equipment, a dedicated special-purpose bearer for an emergency service,
wherein the special-purpose bearer is assigned to handle special-purpose communication services which are not handled by said default bearer.

47. The computer program of claim 46, wherein the default bearer is one of a default radio bearer and a default access bearer, and wherein the special-purpose bearer is one of a special-purpose radio bearer and a special-purpose access bearer.

48. An apparatus, comprising:
default radio bearer assigning means for assigning, to a user equipment, a default radio bearer for a communication service; and
dedicated special-purpose radio bearer assigning means for assigning, to a user equipment, a dedicated special-purpose radio bearer for an emergency service,
wherein the special-purpose radio bearer is assigned to handle special-purpose communication services which are not handled by said default radio bearer.

49. An apparatus, comprising:
default access bearer assigning means for assigning, to a user equipment, a default access bearer for a communication service; and
dedicated special-purpose access bearer assigning means for assigning, to the user equipment, a dedicated special-purpose access bearer for an emergency service,
wherein the special-purpose access bearer is assigned to handle special-purpose communication services which are not handled by said default access bearer.
